(19) United States
(12) Patent Application Publication
(10) Pub. No.: US 2009/0269044 A1
(43) Pub. Date: Oct. 29, 2009

(54) BRIDGESTONE CORPORATION

(75) Inventor: Masafumi Yamakawa, Tokyo (JP)

Correspondence Address: SUGHRUE MION, PLLC, 2100 PENNSYLVANIA AVENUE, N.W., SUITE 800, WASHINGTON, DC, 20037, US

(73) Assignee: BRIDGESTONE CORPORATION, Tokyo (JP)

(21) Appl. No.: 12/297,185

(22) PCT Filed: Mar. 27, 2007
(86) PCT No.: PCT/JP2007/056408

§ 371 Date: Dec. 31, 2008

(30) Foreign Application Priority Data
Apr. 14, 2006 (JP) 2006-112517

(51) Int. Cl. F24H 1/14; H05B 3/10

(52) U.S. Cl. 392/488; 219/553

(57) ABSTRACT

Provided is a small-sized in-line heater which is also capable of rapid heating. This in-line heater includes a ceramic heater, and two piping blocks each including a lid member and a piping block body in which a flow pipe is formed. The piping blocks are disposed to face each other with the ceramic heater interposed in between.

### TECHNICAL FIELD

The present invention relates to an in-line heater and a method for manufacturing the same.

### BACKGROUND ART

As a method for heating a liquid or air a method is proposed, for example, in which a liquid is heated with a large-sized heating apparatus and thereafter supplied to an intended region through a pipe (see Patent Document 1, for example). However, such a method has a problem that the temperature of the liquid decreases with increasing distance between the large-sized heating apparatus and the intended region. In particular, this is a critical issue in the technical field in which temperature control is required.

As means for solving this problem, a technique is proposed in which an in-line heater is disposed as the heating apparatus in the vicinity of the intended region to carry out fine tuning of the temperature of the liquid or the like by use of this in-line heater. In this case, the in-line heater should preferably have a small size from the viewpoint of ensuring work space, and be capable of rapid heating in order to achieve fine tuning of the temperature of the liquid or the like. However, an in-line heater having a small size and being capable of rapid heating has not been found to date.

Against the aforementioned background, there has been a demand for an in-line heater having a small size and being capable of rapid heating.

Patent Document 1: JP-A 7-129252

### DISCLOSURE OF THE INVENTION

The present invention relates to the features described below:

(1) an in-line heater including a ceramic heater, and two piping blocks each including a lid member and a piping block body in which a flow pipe is formed, the piping blocks being disposed to face each other with the ceramic heater interposed in between;
(2) the in-line heater according to clause (1), in which the ceramic heater is made of sintered silicon carbide;
(3) the in-line heater according to clause (1) or (2) further including an insulating bodies each disposed between the ceramic heater and one of the piping blocks;
(4) the in-line heater according to any one of clauses (1) to (3), in which the piping blocks are made of SUS;
(5) the in-line heater according to any one of clauses (1) to (3), in which the piping blocks are made of aluminum;
(6) the in-line heater according to any one of clauses (1) to (3), in which the piping blocks are made of quartz;
(7) the in-line heater according to any one of clauses (1) to (6) further including reflectors respectively disposed on outer surface of the piping blocks; and
(8) the in-line heater according to clause (7), in which the reflectors each include a gold-plated layer on a surface.

### BRIEF DESCRIPTION OF THE DRAWINGS

FIG. 1 shows a perspective view of an in-line heater according to a first embodiment.

FIG. 2 shows a cross-sectional view of the in-line heater according to the first embodiment.

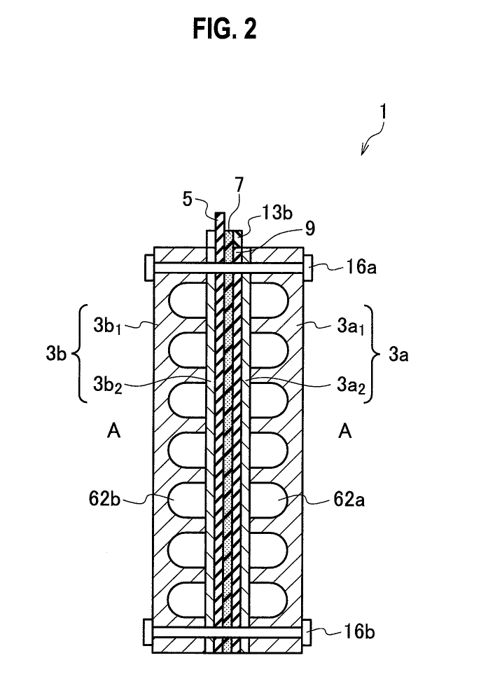

FIGS. 3(a), 3(b) and 3(c) show manufacturing process drawings (No. 1) of the in-line heater according to the first embodiment, in which FIG. 3(a) is a font view, FIG. 3(b) is a side view, and FIG. 3(c) is a cross-sectional view.

FIGS. 4(a), 4(b) and 4(c) show manufacturing process drawings (No. 2) of the in-line heater according to the first embodiment, in which FIG. 4(a) is a font view, FIG. 4(b) is a side view, and FIG. 4(c) is a cross-sectional view.

FIGS. 5(a), 5(b) and 5(c) show manufacturing process drawings (No. 3) of the in-line heater according to the first embodiment, in which FIG. 5(a) is a font view, FIG. 5(b) is a side view, and FIG. 5(c) is a cross-sectional view.

FIGS. 6(a), 6(b) and 6(c) show manufacturing process drawings (No. 4) of the in-line heater according to the first embodiment, in which FIG. 6(a) is a font view, FIG. 6(b) is a side view, and FIG. 6(c) is a cross-sectional view.

FIGS. 7(a) and 7(b) show manufacturing process drawings (No. 5) of the in-line heater according to the first embodiment, in which FIG. 7(a) is a font view, and FIG. 7(b) is a side view.

FIG. 8 shows a side view of the in-line heater according to the first embodiment.

FIG. 9 shows a graph indicating temperature rise characteristics of the in-line heater according to the first embodiment.

FIG. 10 shows a perspective view of an in-line heater according to a second embodiment.

FIG. 11 shows a cross-sectional view of the in-line heater according to the second embodiment.

### BEST MODES FOR CARRYING OUT THE INVENTION

The present invention will be described below based on embodiments. However, the present invention is not limited to the following embodiments. Members having identical or similar functions are designated by identical or similar reference numerals, and explanations thereof will be thereby omitted.

### First Embodiment

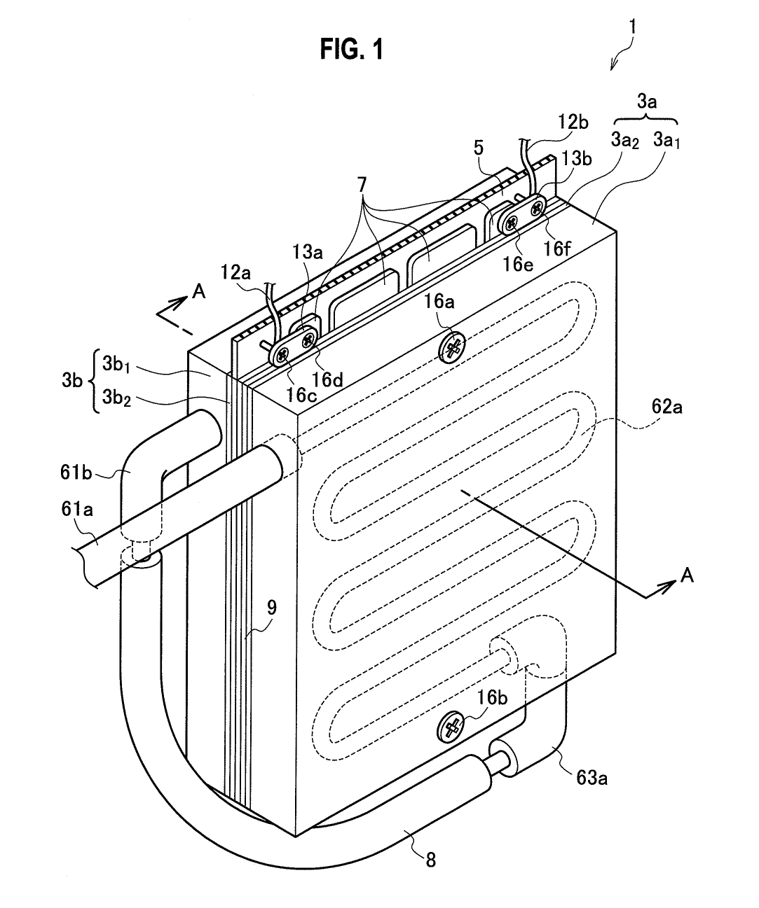

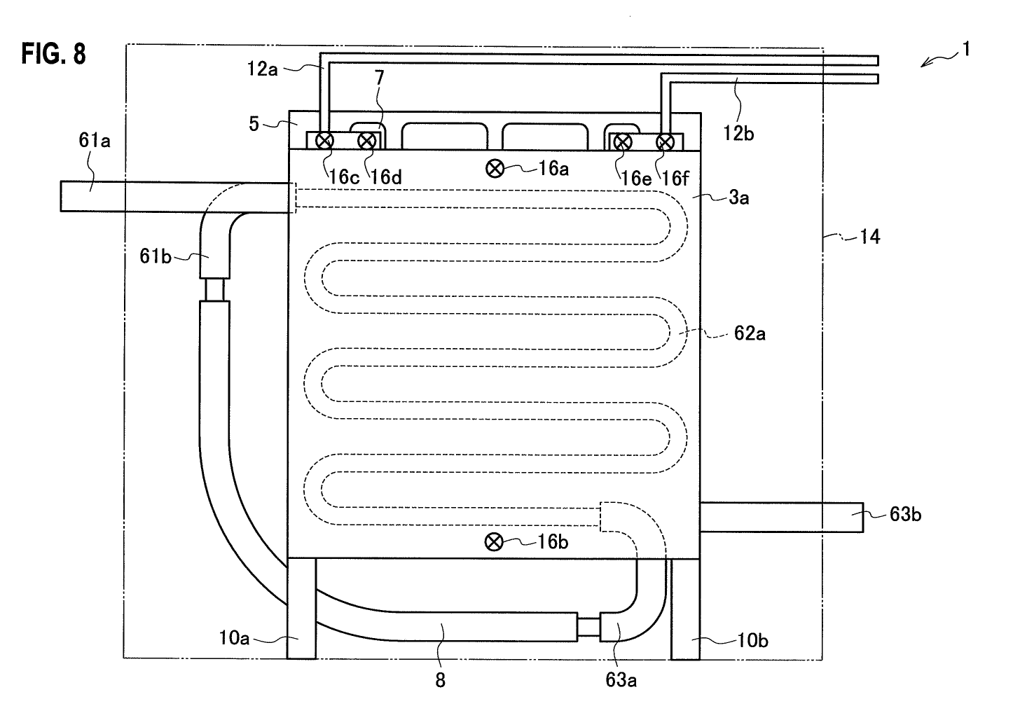

An in-line heater 1 according to a first embodiment of the present invention shown in FIGS. 1 and 8 includes a ceramic heater 7, and a set of piping blocks 3a and 3b disposed to face each other with the ceramic heater 7 interposed in between. Moreover, the in-line heater 1 includes insulating plates 5 and 9 disposed between the ceramic heater 7 and the piping blocks 3a and 3b. The ceramic heater 7 is connected to a power source (not shown) through electrode plates 13a and 13b, and lines 12a and 12b. Moreover, the in-line heater 1 is connected to a pump (not shown) through an inlet 61a of a first flow pipe.

The ceramic heater 7 is preferably made of sintered silicon carbide, because the sintered silicon carbide has high purity and therefore has a very low risk to contaminate a heated material in heating. The ceramic heater 7 made of the sintered silicon carbide can be manufactured by a reaction sintering method, a hot press sintering method or a cast molding method, for example. The hot press sintering method and the cast molding method will be described later.

The first piping block 3a includes a piping block body 3a₁ and a lid member 3b₂. The piping block 3a includes a groove (6a) formed on a principal surface on the ceramic heater 7 side of the piping block body 3a₁ so as to form a first flow pipe 62a when the lid member 3b₂ is disposed on the piping block body 3a₁. The piping block body 3a₁ and the lid member 3b₂ are joined together by welding or the like. The second piping block 3b₁ also has a similar configuration to the first piping block 3a. An outlet 63a of the formed first flow pipe is connected to an inlet 61b of a second flow pipe by use of a flexible tube or a metal pipe (such as a SUS pipe) 8. The first and second piping blocks 3a and 3b are made of aluminum (or stainless steel (SUS)), which can be manufactured by use of a casting method or a milling machine method, for example.

The insulating plates 5 and 9 are not always indispensable but are preferably provided from the viewpoint of preventing an electrical short-circuit to the ceramic heater 7. The insulating plates 5 and 9 are made of, for example, alumina, quartz, aluminum nitride or the like, and should preferably be made of a material having a high heat conductivity. Particularly, the insulating plates 5 and 9 should be made of aluminum nitride from the viewpoint of an insulation property and high heat conductivity.

[Method of Manufacturing in-Line Heater]

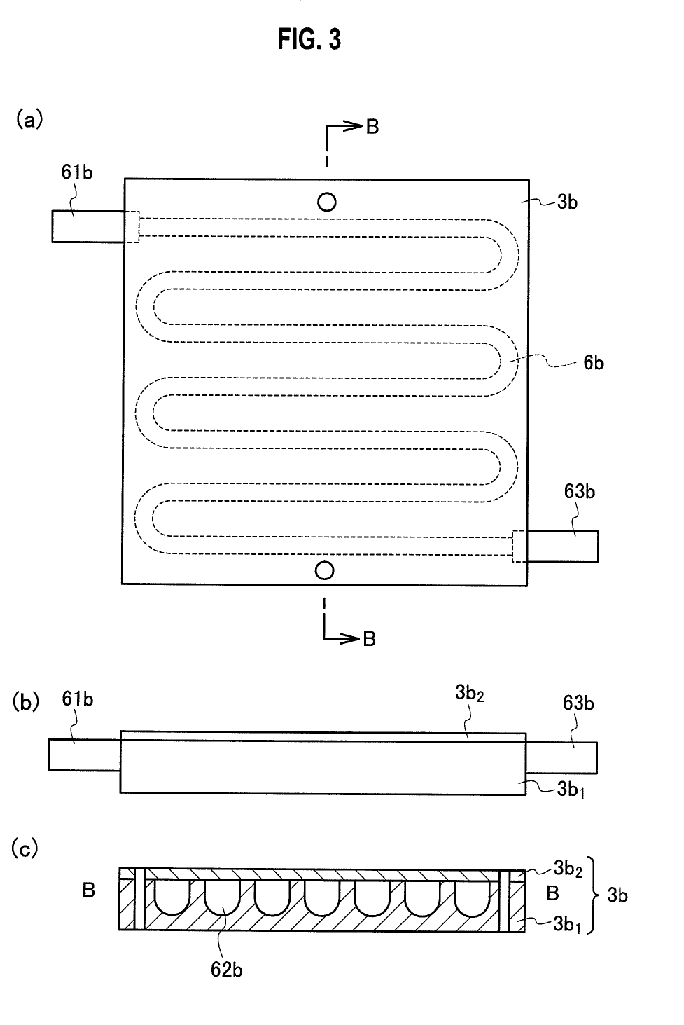

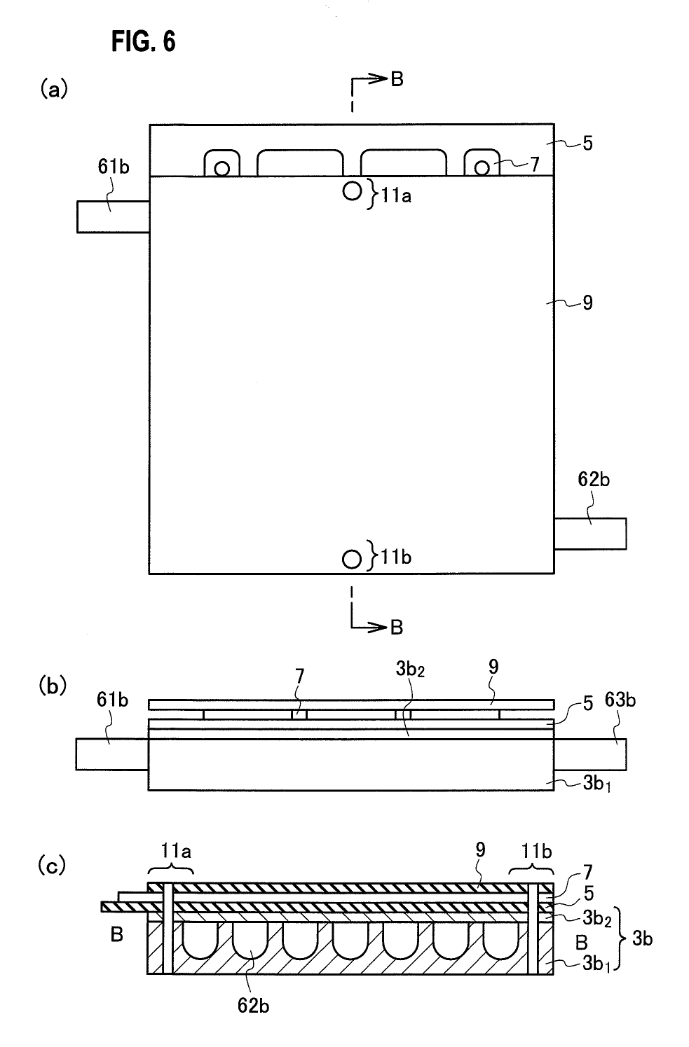

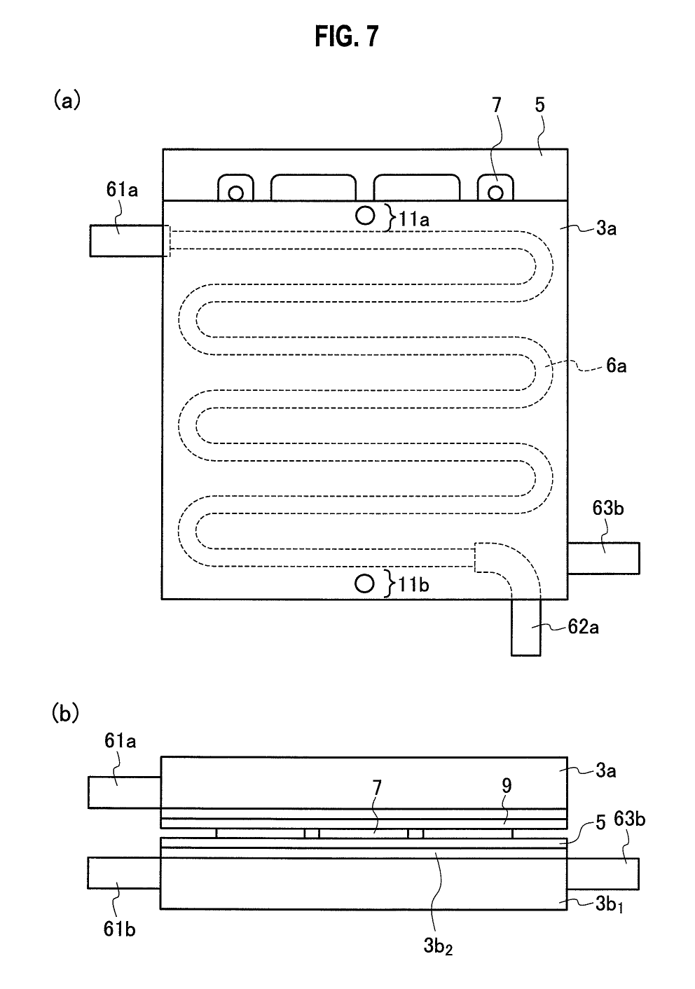

The configuration of the in-line heater 1 will be described further in detail through explanation of a method of manufacturing the in-line heater 1 using FIGS. 3 to 8. First, formed is the piping block body 3b₁ made of SUS and provided with a groove 6b indicated with phantom lines in FIG. 3(a), the inlet 61b of the second flow pipe, and an outlet 63b of the second flow pipe. Next, the lid member 3b₂ is joined to the piping block body 3b₁ by welding or the like. Then, a second flow pipe 62b is formed as shown in FIG. 3(c).

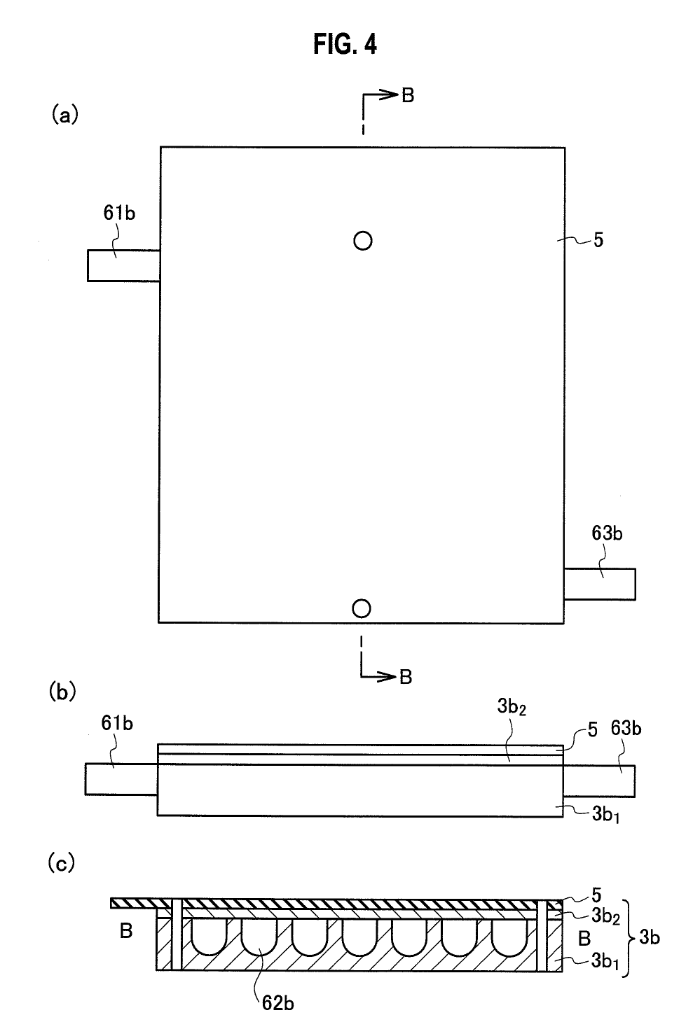

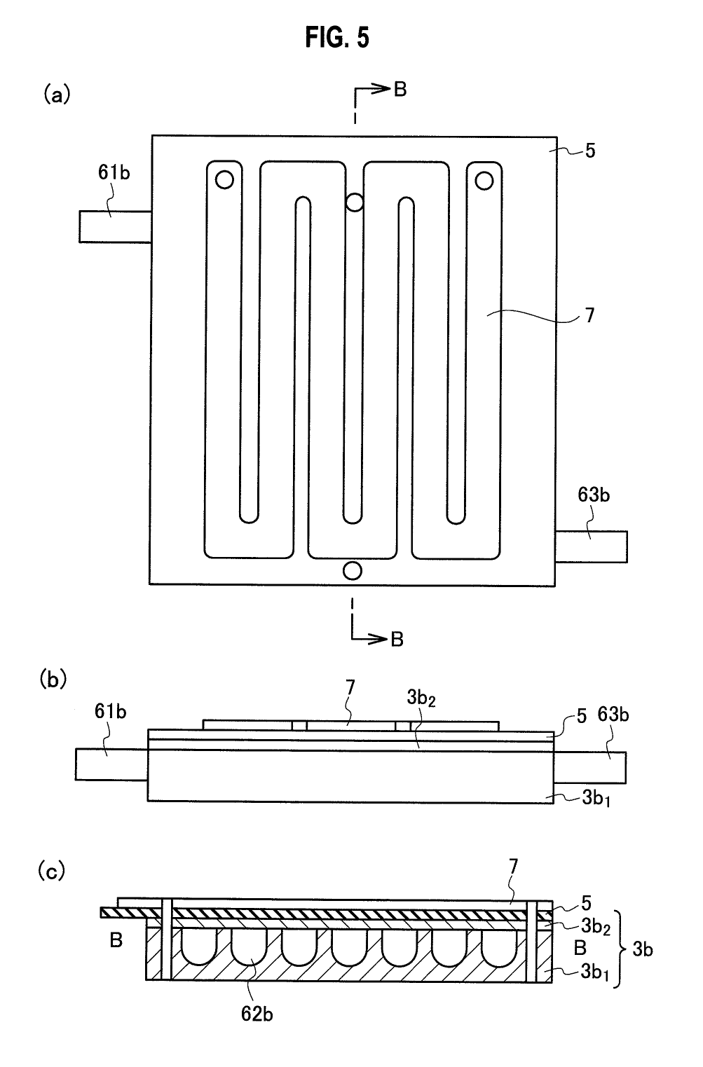

Subsequently, as shown in FIGS. 4(a), 4(b), and 4(c), the insulating plate 5 is disposed on the formed piping block body 3b. Moreover, as shown in FIGS. 5, 6, and 7, the ceramic heater 7, the insulating plate 9, and the piping block 3a are arranged in this order. Then, the entire constituents are fixed together with screws 16a and 16b via through holes 11a and 11b that are provided on the piping blocks 3a and 3b, the insulating plates 5 and 9, and the ceramic heater 7.

Next, the in-line heater 1 is disposed on bases 10a and 10b as shown in FIG. 8, and then the outlet 63a of the first flow pipe is connected to the inlet 61b of the second flow pipe by using the flexible tube 8. Moreover, the lines 12a and 12b are connected to the ceramic heater 7 by using bolts 16d and 16e. Further, the in-line heater 1 may be covered with an external case 14 indicated by the phantom line. The external case 14 is preferably made of aluminum or SUS, for example. In this way, the in-line heater 1 is formed.

As the in-line heater 1 according to the first embodiments includes the above-described specific features of the invention, a heating object introduced from the inlet 61a of the first flow pipe flows from the first flow pipe 62a to the second flow pipe 62b through the flexible tube 8, is discharged from the outlet 63b of the second flow pipe, and sent to a intended region. The heating object is heated from both surfaces of the ceramic heater 7 by flowing inside the first flow pipe 62a and the second flow pipe 62b. For this reason, heating efficiency is improved as compared to heating the heating object from one surface of the ceramic heater 7. Moreover, in the case of a heating apparatus of a single surface heating system, it is necessary to dispose a heat insulator on the surface opposite to the surface of the heater which the heating object contacts in order to prevent a temperature rise outside the heating apparatus. In the first embodiment, the piping blocks 3a and 3b are arranged while interposing the ceramic heater 7 and the temperature rise outside of the in-line heater 1 is thereby prevented. Accordingly, it is unnecessary to arrange any heat insulators around the in-line heater 1. As a consequence, the in-line heater 1 can be downsized and simplified. Moreover, the in-line heater 1 according to the first embodiment does not have limitations for the power source and the like and is therefore easy to handle.

The heating object to be heated by the in-line heater 1 also includes a gas in addition to a liquid. The liquid may be, for example, water, a fluorine-containing solvent such as Galden, perfluorocarbon or Fluorinert. The gas may, for example, be nitrogen or the like.

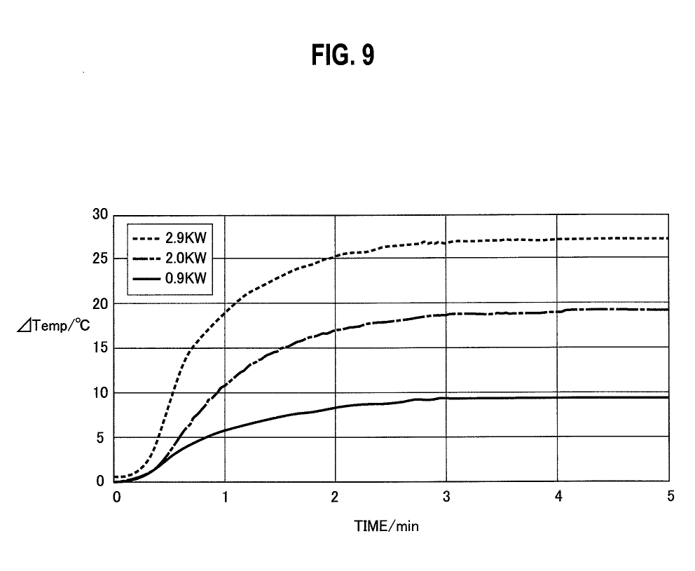

FIG. 9 is a view showing temperature rise characteristics when electric powers of 0.9 KW, 2.0 KW, and 2.9 KW are applied to the in-line heater 1 according to the first embodiment. In FIG. 9, the longitudinal axis indicates a temperature difference ΔT between an entering water temperature before introduction to the in-line heater 1 and an outgoing water temperature, while the lateral axis indicates elapsed time (t) until the temperature of the fluid heated by the in-line heater 1 reaches a saturation temperature thereof. The in-line heater 1 according to the first embodiment has an extremely good rising-edge characteristic.

### Second Embodiment

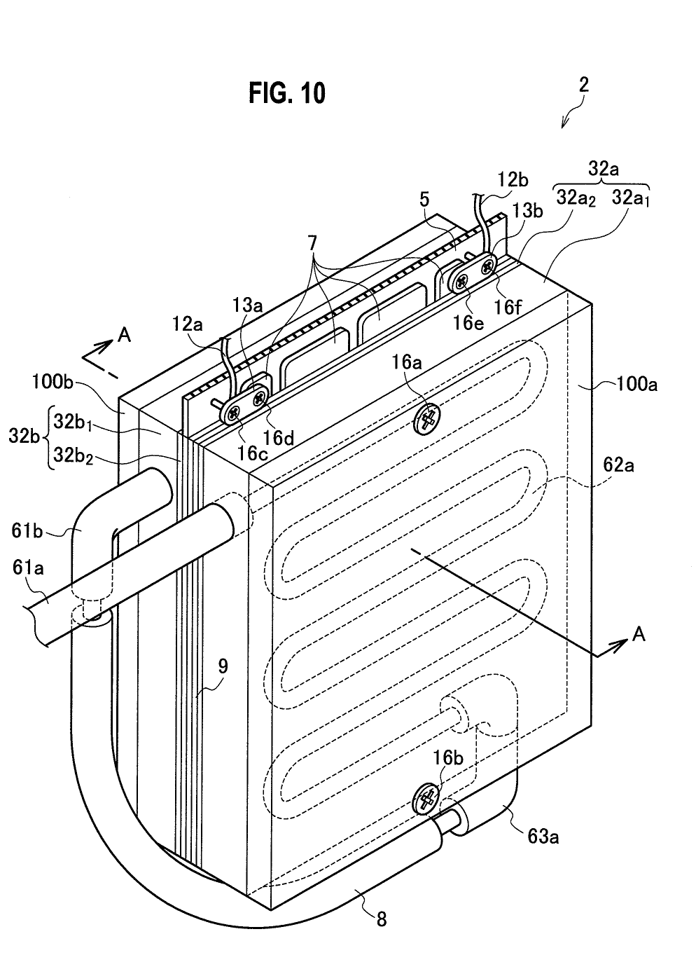

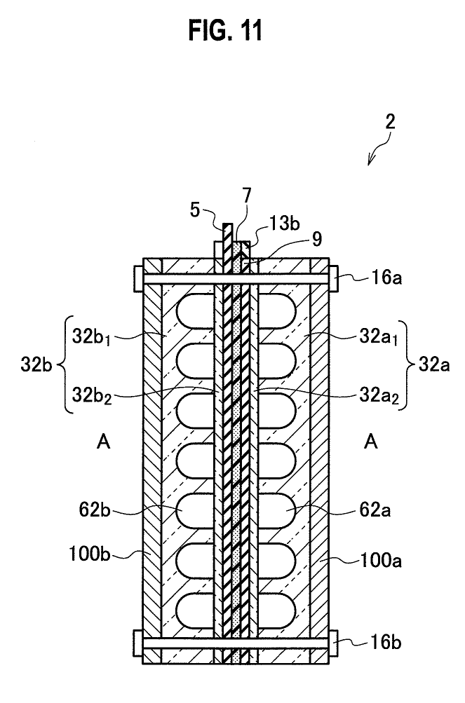

An in-line heater 1 according to a second embodiment of the present invention shown in FIGS. 10 and 11 includes a ceramic heater 7, and a set of piping blocks 32a and 32b disposed to face each other with the ceramic heater 7 in between. Moreover, the in-line heater 1 includes insulating plates 5 and 9 disposed between the ceramic heater 7 and the piping blocks 32a and 32b, and reflectors 100a and 100b disposed with the piping blocks 32a and 32b interposed in between. The ceramic heater 7 is connected to a power source (not shown) through electrode plates 13a and 13b, and lines 12a and 12b. Moreover, the in-line heater 1 is connected to a pump (not shown) through an inlet 61a of a first flow pipe.

The first piping block 32a has a similar configuration to the first piping block 3a of the first embodiment except for being made of quartz. The same applies to the second piping block 32b. As the first piping block 32a and the second piping block 32b are made of quartz, there are obtained an operation and an effect that a metal-free and high-purity liquid such as purified water can be flown without being contaminated by an impurity.

By providing the reflectors 100a and 100b, there are obtained an operation and an effect that radiation heat in addition to heat from the ceramic heater 7 can be utilized to improve thermal efficiency. Although the reflectors 100a and 100b do not have particular limitations as long as they can utilize the radiation heat, aluminum, SUS, and the like may be used. From the viewpoint of improving use efficiency of the radiation heat, gold-plated layers are preferably provided on surfaces of the reflectors 100a and 100b.

### [Hot Press Sintering Method]

A method of manufacturing silicon carbide to be used for manufacturing the in-line heater 1 will be described below.

In the method of manufacturing the in-line heater 1 according to the first embodiment, preferably used is sintered silicon carbide having a free carbon content ranging from 2 to 10 wt %. Such sintered silicon carbide is obtained by burning a mixture of silicon carbide powder and a nonmetal sintering additive. The silicon carbide powder will be described to begin with. A wide variety of the silicon carbide powder such as an α-type, a β-type, an amorphous type or mixtures thereof may be used. Commercially available products may also be used. Among them, the β-type silicon carbide powder is suitably used. In order to achieve high density of the sintered silicon carbide, it is better for the used silicon carbide powder to have smaller grain sizes. The grain sizes are preferably in a range from about 0.01 μm to 10 μm, or more preferably in a range from 0.05 μm to 2 μm. When the grain sizes fall below 0.01 μm, handling in a processing step such as measuring or mixing is difficult. By contrast, when the grain sizes exceed 10 μm, the specific surface area of the powder, i.e. contact areas with adjacent grains are reduced. This is not preferable because it is difficult to achieve higher density.

Use of high-purity silicon carbide powder is preferable, because this causes the obtained sintered silicon carbide to have a high purity. The high-purity silicon carbide powder can be manufactured, for example, by mixing: a silicon compound (which will be hereinafter referred to as a “silicon source” as appropriate); an organic material capable of generating carbon upon being heated; and either a Z-polymerization catalyst or a cross-linking catalyst, and then by burning a solid thus obtained in a non-oxidizing atmosphere. Although a wide variety of liquid and solid compounds can be used as the silicon source, at least one liquid compound is used herein. The liquid silicon source may be (mono-, di-, tri- or tetra-) alkoxysilane polymers, for example. Among the alkoxysilane polymers, tetraalkoxysilane polymers are suitably used. To be more precise, although there are methoxysilane, ethoxysilane, propyloxysilane, butoxysilane, and so forth, ethoxysilane is preferable in light of handling. Tetraalkoxysilane polymers are formed into liquid low-molecular-weight polymers (oligomers) at a degree of polymerization in a range from about 2 to 15. In addition, there is also a liquid type silicate polymer having a high degree of polymerization. A solid silicon source usable together with a liquid silicon source may be silicon carbide, for example. The silicon carbide cited herein includes silicon monoxide (SiO), silicon dioxide (SiO₂), and moreover, silica sol (which is a liquid containing colloidal ultrafine silica, where colloidal molecules contain an OH base or an alkoxy group), superfine silica, quartz powder, and the like. Among these silicon sources, tetraalkoxysilane oligomers or a mixture of tetraalkoxysilane oligomers and fine silica powder, and the like having excellent homogeneity and handling performance are particularly preferred. Moreover, these silicon sources preferably have high purity. To be more precise, the initial impurity content is preferably equal to or below 20 ppm, or more preferably equal to or below 5 ppm.

As for the organic material capable of generating carbon upon being heated, it is possible to use a liquid substance, and also to use a liquid substance and a solid substance at the same time. An organic material having a high actual carbon ratio and designed to be polymerized or cross-linked either by a catalyst or by heating is preferable. To be more precise, monomers or prepolymers of phenol resin, furan resin, polyimide, polyurethane, polyvinyl alcohol, and the like are preferable. In addition, liquid materials such as cellulose, sucrose, pitch or tar are also used. Among them, resole type phenol resin is preferable in light of pyrolytic property and purity. The purity of the organic material may be appropriately controlled to meet the object. In particular, when high-purity silicon carbide powder is necessary, an organic material having the content of each of impurities below 5 ppm is preferably used.

A preferable range of a combination ratio between the silicon source and the organic material can be determined in advance based on a mole ratio of carbon and silicon (hereinafter abbreviated as “C/Si”) used as an indicator. The ratio “C/Si” cited herein is C/Si derived from an analytical value of a silicon carbide intermediate obtained by subjecting the mixture of the silicon source and the organic material to carbonization at 1000° C. As expressed in the following reaction formula, carbon reacts with silicon oxide and changes into silicon carbide.

In accordance with formula (I) SiO₂+3C→SiC+2CO, the free carbon in the silicon carbide intermediate becomes stoichiometrically equal to 0% when the C/Si is equal to 3.0. However, in reality the free carbon is generated even when C/Si is a lower value due to sublimation of SiO gas and the like. Since the free carbon has an effect to suppress grain growth, the C/Si may be determined according to grain sizes of target powder grains, and the silicon source and the organic material may be blended to meet that ratio. For example, when the mixture of the silicon source and the organic material is burned at about 1 atmosphere and equal to or above 1600° C., generation of free carbon can be suppressed by blending the silicon source and the organic material so as to set the C/Si in a range from 2.0 to 2.5. When the silicon source and the organic material are blended under the same conditions to set the C/Si more than 2.5, free carbon is generated remarkably and silicon carbide powder having small grains is obtained. In this way, the combination ratio can be determined appropriately according to the purpose. Here, an operation and an effect of free carbon attributable to the silicon carbide powder are extremely weaker than an operation and an effect of free carbon derived from a sintering additive. Accordingly, the free carbon attributable to the silicon carbide powder does not have an intrinsic influence on the effect of the present invention.

Meanwhile, the entire carbon amount contained in the silicon carbide powder is preferably not less than about 30 wt %, but not more than about 40 wt %. The total carbon content of the silicon carbide (SiC) is theoretically equal to about 30 wt %. However, the content becomes less than 30 wt % when non-carbon impurities are included, while the content becomes more than 30 wt % when the free carbon is included. The silicon carbide powder prepared by adding the organic material and then burning as described above contains the carbon impurities, so that the carbon content in the silicon carbide powder becomes greater than 30 wt %. Therefore, if the carbon content in the silicon carbide powder falls below 30 wt %, this means a high proportion of the non-carbon impurity which is not favorable in terms of purity. By contrast, if the content exceeds 40 wt %, the density of the obtained sintered silicon carbide is decreased and it is therefore not favorable in terms of strength, oxidation resistance and the like.

The mixture of the silicon source and the organic material may be hardened to form a solid. The hardening method may be a method of using a cross-link reaction by heating, a hardening method using a curing catalyst, a method using an electron beam or radiation, and the like. The curing catalyst used herein may be appropriately selected according to the used organic material. When the phenol resin or the furan resin is used as the organic material, the catalyst may be carbonic acids such as toluene sulfonic acid, toluene carbonic acid, acetic acid or oxalic acid; inorganic acids such as hydrochloric acid or sulfuric acid; amines such as hexamine; and the like. The solid containing the silicon source and the organic material is subjected to heating and carbonization as appropriate. Carbonization is executed by heating in a non-oxidizing atmosphere such as nitrogen or argon at a temperature in a range from 800° C. to 1000° C. for 30 to 120 minutes. Moreover, silicon carbide is generated by heating in the non-oxidizing atmosphere at a temperature in a range from 1350° C. to 2000° C. The burning temperature and burning time may be appropriately determined because they have influences on grain sizes and the like of the obtained silicon carbide powder. However, burning at a temperature in a range from 1600° C. to 1900° C. is efficient and favorable. The method of obtaining the high-purity silicon carbide powder as explained above is described further in detail in the description of JP-A H9-48605.

Next, a nonmetal sintering additive will be described. The sintered silicon carbide used in the present invention contains the free carbon in a range from 2 wt % to 10 wt %. This free carbon is attributed to the organic material used in the nonmetal sintering additive, so that the amount of free carbon can be set in the above-mentioned range by adjusting additive conditions such as an amount of addition of the nonmetal sintering additive.

As the nonmetal sintering additive, a material that can serve as a free carbon source as described above, i.e., an organic material capable of generating carbon upon being heated (hereinafter referred to as “carbon source” when applicable) is used. The above-described material may be singly used, or the above-described organic material with surfaces of silicon carbide powder coated therewith (grain sizes: about 0.01 to 1 μm) may be used as the sintering additive. However, from the viewpoint of effectiveness, it is preferable to use the organic material singly. To be more precise, Organic material capable of generating carbon upon being heated includes: materials each having a high actual carbon ratio such as coal tar pitch, pitch tar, phenol resin, furan resin, epoxy resin and phenoxy resin; various sugars including monosaccharides such as glucose, oligosaccharides such as sucrose, and polysaccharides such as cellulose and starch; and the like. In order to mix the organic material homogeneously with the silicon carbide powder, the organic material should preferably be in liquid form at room temperature, soluble to a solvent, or provided with a thermoplastic, thermal melting property or the like to be softened by heating. Among them, phenol resin is preferable, because the strength of the sintered silicon carbide is enhanced, and resole type phenol resin is more preferable. Although operations and mechanisms of these organic materials are not clarified, the organic material forms an inorganic carbon compound that is similar to carbon black or graphite inside the system, when heated. This inorganic carbon compound appears to operate effectively as the sintering additive. However, if the carbon black or the like is used as the sintering additive, a similar effect is not obtained.

The nonmetal sintering additive may be dissolved in an organic solvent as desired, and then the solution may be mixed with the silicon carbide powder. The organic solvent used therein varies depending on the nonmetal sintering additive. For example, when phenol resin is used as the sintering additive, lower alcohol such as ethyl alcohol, ethyl ether, acetone, or the like may be selected. When a high-purity sintered silicon carbide is fabricated, it is preferable to use not only the high-purity silicon carbide powder but also the sintering additive and the organic solvent having lower contents of impurities.

An amount of addition of the nonmetal sintering additive to the silicon carbide powder is determined so as to have the free carbon in the sintered silicon carbide in a range from 2 wt % to 10 wt %. If the free carbon deviates from this range, this causes an insufficient chemical change to SiC that progresses during a bonding process and insufficient connection in the sintered silicon carbide. Here, the content (wt %) of the free carbon can be calculated from measured values obtained by heating the sintered silicon carbide in an oxygen atmosphere at 800° C. for 8 minutes and by measuring amounts of generated CO₂ and CO with a carbon analyzer. The amount of addition of the sintering additive varies depending on the type of the sintering additive used therein and on an amount of surface silica (silicon oxide) of the silicon carbide powder. As for an indicator to determine the amount of addition, the amount of surface silica (silicon oxide) of the silicon carbide powder is quantized in advance by use of hydrofluoric acid, and the stoichiometry sufficient for reducing this silicon oxide (the stoichiometry calculated by formula (I)) is calculated. The amount of addition can be determined so as to set the free carbon in the above-mentioned range, while this value and a proportion that the nonmetal sintering additive can generate carbon by heating are considered. The explanation of the nonmetal sintering additive for the sintered silicon carbide explained above is described further in detail in the description of JP-A 9-041048.

Next, a method of sintering the mixture of the silicon carbide powder and the nonmetal sintering additive will be described. The silicon carbide powder and the nonmetal sintering additive are homogeneously mixed. To obtain the homogeneous mixture, the solution with the sintering additive dissolved into the organic solvent as previously described may be used. The mixing method may apply a publicly known method such as a method of using a mixer, a planetary ball mill or the like. As for apparatuses used for mixing, tools made of synthetic resin materials are preferably used in order to avoid incorporation of metal element impurities. Mixing is preferably performed for some 10 to 30 hours or in particular for some 16 to 24 hours for sufficient mixing. After the sufficient mixing, the solvent is removed and the mixture is dried and hardened through evaporation. Thereafter, raw material powder of the mixture is obtained by using a sieve. A granulating machine such as a spray dryer can also be used for drying.

The raw material powder thus obtained is put into a molding die. A molding die made of graphite is preferably used, because no metal impurity contaminates the sintered silicon carbide. A molding die made of metal can also be suitably used by forming a contact portion made of graphite so as to avoid direct contact between the raw material powder and a metallic portion of the die or by interposing a polytetrafluoroethylene sheet (Teflon (registered trademark) sheet) at the contact portion therebetween. Particularly, when manufacturing a high-purity sintered silicon carbide is intended, a high-purity graphite material is preferably used for the mold, a heat insulator inside a furnace, and the like. To be more precise, there is cited a graphite material which is sufficiently baked in advance at a temperature equal to or above 2500° C. so as to eliminate generation of impurities even in use at a high temperature, for example.

The raw material powder put into the molding die is subjected to hot pressing. As for a pressure at hot pressing, a pressure in a wide range from 300 kgf/cm² to 700 kgf/cm² can be used for performing hot pressing. However, when a pressure equal to or above 400 kgf/cm² is applied, it is necessary to use components having excellent pressure resistances as components for hot pressing such as a dice or punch.

Hot pressing is conducted in a temperature range from 2000° C. to 2400° C. Here, it is preferable to raise the temperature to this hot pressing temperature gently and stepwise. By raising the temperature in this way, chemical changes and conditional changes caused at respective temperature zones can be progressed sufficiently and as a consequence, occurrence of impurity contamination, cracks or pores can be prevented. A preferred example of the temperature raising process will be described below. First, a mold die filled with 5 g to 10 g of the raw material powder is disposed in a furnace and the inside of the furnace is set to a vacuum state of 10⁻⁴ torr. The temperature is gently raised from a room temperature to 200° C., and then maintained at 200° C. for 30 minutes. Subsequently, the temperature is raised for 6 to 10 hours to reach 700° C., and then maintained at 700° C. for 2 to 5 hours. Detachment of absorbed moisture and the organic solvent occurs in the process of raising the temperature from the room temperature to 700° C., and carbonization of the nonmetal sintering additive also progresses. The retention time at the constant temperature varies depending on the size of the sintered silicon carbide so a suitable time period may be set as appropriate. Meanwhile, a judgment as to whether or not the retention time is sufficient may be made at approximately a time point when reduction of the degree of vacuum decreases to some extent. Next, the temperature is raised from 700° C. to 1500° C. for 6 to 9 hours and the temperature is maintained at 1500° C. for about 1 to 5 hours. A reaction in which silicon oxide is reduced and changed into silicon carbide (formula (I)) progresses during the period when the temperature is maintained at 1500° C. If the retention time is inadequate, silicon dioxide remains and attaches to the surfaces of the silicon carbide powder, which is not favorable because of hindering densification of grains and causing growth of large grains. A judgment as to whether or not the retention time is sufficient may be made based on discontinuation of generation of carbon monoxide which is a byproduct of the above reaction, as an indicator. That is, the above determination may be made based on whether or not reduction of the degree of vacuum slows down and thereby the degree of vacuum returns to a degree corresponding to a temperature of 1300° C., which is a starting temperature of the reducing reaction.

Hot pressing is preferably performed after the temperature inside of the furnace is raised up to about 1500° C. to initiate sintering and then inert gas is filled in the furnace so as to have the non-oxidizing atmosphere therein. Nitrogen gas, argon gas or the like is used as the inert gas. Here, it is preferable to use argon gas which is inactive at a high temperature. When the manufacturing of the high-purity sintered silicon carbide is intended, the high-purity inert gas should also be used. After the non-oxidizing atmosphere is established inside the furnace, the inside of the furnace is heated and pressurized so as to achieve a temperature in a range from 2000° C. to 2400° C. and the pressure in a range from 300 kgf/cm² to 700 kgf/cm². If the maximum temperature is below 2000° C., high densification is performed inadequately. By contrast, if the temperature exceeds 2400° C., this is not preferable because the powder or a raw material of a molded body may be sublimated (decomposed). The temperature is preferably raised from close to 1500° C. to the maximum temperature for 2 to 4 hours, and maintained at the maximum temperature for 1 to 3 hours. The sintering action rapidly progresses in a temperature range from 1850° C. to 1900° C., and is completed during the retention time at the maximum temperature. Meanwhile, when the pressurization condition is below 300 kgf/cm², high densification is insufficiently performed. When the pressure exceeds 700 kgf/cm², the molding die made of graphite may be damaged. These are not favorable in light of manufacturing efficiency. In order to suppress growth of abnormal grains, pressurization is preferably performed at a pressure in the range of about 300 kgf/cm² to 700 kgf/cm².

The used sintered silicon carbide is preferably highly densified to have the density equal to or above 2.9 g/cm³ and porosity equal to or below 1%. It is particularly preferable to achieve the density equal to or above 3.0 g/cm³ and the porosity equal to or below 0.8%. Use of the highly densified sintered silicon carbide improves mechanical characteristics such as bending strength and fracture strength, as well as electrical properties, of the obtained silicon carbide bonded body. Moreover, use of the highly densified sintered silicon carbide is also preferable in light of a contamination property because the constituent grains are reduced in size. On the contrary, if a low-density or porous sintered silicon carbide is used, for example, thermal resistance, oxidation resistance, chemical resistance, and mechanical strength of the sintered silicon carbide may be degraded. Meanwhile, bonding strength may also be inadequate.

As a method of highly densifying the sintered silicon carbide, there is a method of carrying out a molding step prior to a sintering step. This molding step is carried out at a lower temperature and a lower pressure as compared to the sintering step. By carrying out this sintering step, powder having a large volume can be made compact (smaller in size) in advance. Accordingly, the manufacturing of a large-sized molded body is facilitated by repeating this step many times. An example of various conditions of the molding step to be carried out prior to the sintering step will be shown below. Material powder obtained by homogeneously mixing the silicon carbide powder and the nonmetal sintering additive is put into the molding die, and the molded body is obtained by pressing at a temperature in a range from 80° C. to 300° C. or preferably in a range from 120° C. to 140° C., and at a pressure in a range from 50 kgf/cm² to 100 kgf/cm² for 5 to 60 minutes or preferably for 20 to 40 minutes. The heating temperature may appropriately be determined according to the characteristic of the nonmetal sintering additive. Pressing is preferably performed so as to achieve the density of the obtained molded body equal to or above 1.8 g/cm² when powder having an average grain size of about 1 μm is used, or equal to or above 1.5 g/cm² when powder having an average grain size of about 0.5 μm is used. The density of the used molded body in this range is preferable, as it is easier to achieve higher densification of the sintered silicon carbide. The molded body may be subjected to a cutting process so that an obtained molded body can fit in the molding die used in the sintering step.

The total content of impurity elements (elements having atomic numbers of 3 or greater in the periodic table of the elements in the revised nomenclature of inorganic chemistry, IUPAC, 1989, excluding C, N, O, and Si) in the sintered silicon carbide used in the present invention is preferably equal to or below 5 ppm, because the sintered silicon carbide is usable to a process that requires a higher degree of cleanness such as a semiconductor manufacturing process. More preferably, the total content of the impurity elements is set equal to or below 3 ppm, and particularly preferably set equal to or below 1 ppm. However, the content of impurities based on a chemical analysis just has a meaning as a reference value for an actual use. For example, even if the contents of impurities are the same, evaluations of contamination properties of the silicon carbide bonded body may be different depending on whether the impurities are uniformly distributed or unevenly and locally distributed. Here, the sintered silicon carbide having the impurity content equal to or below 1 ppm can be obtained by using the materials concretely described above and the materials using the sintering method described above. Meanwhile, in order to reduce the content of the impurity elements in the sintered silicon carbide, there are methods such as a method of setting the contents of impurity elements included in the used raw materials (such as the silicon carbide powder and the nonmetal sintering additive) and in the inert gas equal to or below 1 ppm, and a method of removing the impurities by adjusting the various sintering conditions such as the sintering time or the temperature. Here, as similar to the above description, the impurity elements mean the elements having atomic numbers of 3 or greater in the periodic table of the elements in the revised nomenclature of inorganic chemistry, IUPAC, 1989 (but excluding C, N, O, and Si).

Other physical property values of the sintered silicon carbide used in the present invention are preferably set for bending strength at a room temperature to be in a range from 550 kgf/mm² to 800 kgf/mm², for the Young's modulus to be in a range from 3.5×10⁴ to 4.5×10⁴, for the Vickers hardness to be in a range from 550 kgf/mm² to 800 kgf/mm², for the Poisson's ratio to be in a range from 0.14 to 0.21, for the thermal expansion coefficient to be in a range from 3.8×10⁻⁶ l/° C. to 4.2×10⁻⁶ l/° C., for thermal conductivity to be equal to or above 150 W/m·K, for specific heat to be in a range from 0.15 cal/g·° C. to 0.18 cal/g·° C., for thermal shock resistance to be in a range from 500 ΔT° C. to 700 ΔT° C., and for specific resistance to be equal to 1Ω·cm, so that various characteristics of the obtained silicon carbide bonded body become favorable. Here, the sintered silicon carbide disclosed in the description of JP-A H9-041048 by the inventors of the present invention can be suitably used as the sintered silicon carbide of the present invention.

### [Cast Molding Method]

Sintered silicon carbide (a porous body) suitable for a silicon carbide heater is obtained in accordance with the following steps.

### (1) Step of Obtaining Mixed Powder

First, slurry-like mixed powder is manufactured by dispersing silicon carbide powder and an antifoam agent in a solvent. Next, agitation and mixing are performed over a period ranging from 6 hours to 48 hours, or more specifically 12 hours to 24 hours by using agitating and mixing means such as a mixer or a planetary ball mill. If agitation or mixing is not executed sufficiently, gas bubbles are not uniformly dispersed into a green body.

### (2) Step of Obtaining Green Body

The slurry-like mixed powder thus obtained is introduced to a cast molding die. Then, after leaving and detaching from the die, the solvent is removed by means of either heat-drying or naturally drying under a temperature condition ranging from 40° C. to 60° C. In this way, a green body having predetermined dimensions is obtained, i.e., a silicon carbide molded body which contains numerous gas bubbles and is obtained by removing the solvent from the slurry-like mixed powder.

### (3) First Heating Step

The obtained green body is heated up to a range from 550° C. to 650° C. for about two hours under a vacuum atmosphere. The heating temperature below 550° C. leads to insufficient degreasing. Moreover, degreasing is terminated around 650° C. For this reason, the green body is heated at a constant temperature within the above-mentioned heating temperature range. The heating rate is set equal to or below 300° C./1 h in order to prevent explosion attributable to sudden thermal decomposition of a binder in the compound. After the temperature reaches the constant temperature, a calcinated body is obtained by retaining the green body under the temperature condition for 30 minutes in the vacuum atmosphere.

### (4) Second Heating Step

Next, the obtained calcinated body is heated up to a temperature equal to or above 1500° C. under a nitrogen gas atmosphere. Preferably, the calcinated body is heated up to a temperature in a range from 1500° C. to 2000° C., or in a range from 1500° C. to 1950° C. The reason for setting an upper limit of the heating temperature to 2000° C. is that an amount of nitrogen to be doped in the nitrogen atmosphere reaches a state of equilibrium around 2000° C. and, therefore heating at a higher temperature is not economical. Moreover, the furnace will be destroyed at a temperature equal to or above 2400° C. Meanwhile, the strength is degraded if the heating temperature deviates from the range from 1500° C. to 2000° C. For this reason, the calcinated body is heated up to a constant temperature within this temperature range. At this time, from the viewpoint of increasing the strength, the heating temperature is preferably set in a range from 1700° C. to 2000° C. Then, after the temperature reaches the constant temperature, the calcinated body is retained under the temperature condition for 0.5 to 8 hours in a nitrogen-containing atmosphere. In the case of the same heating temperature, the amount of nitrogen inside the sintered silicon carbide is increased by setting at least any one of the conditions of (a) extending the retention time and (b) raising the pressure (atm). The pressure in the nitrogen gas atmosphere is set preferably in a range from −0.5 kg/m² to 0.2 kg/m².

### [Sintered Silicon Carbide (Porous Body)]

The sintered silicon carbide (a porous body) for the heater according to the embodiment of the present invention obtained by the above-described manufacturing process has porosity in a range from 1% to 32%, or preferably in a range from 5% to 29%. Meanwhile, resistance at 100° C. is in a range from 0.02 Ωcm to 0.06 Ωcm, or preferably in a range from 0.03 Ωcm to 0.05 Ωcm. Where the resistance at 100° C. is A and the resistance at 1000° C. is B, B/A=0.2 to 2 holds true. By providing such physical properties, the problem of the temperature dependency is drastically improved. Moreover, the nitrogen content in this embodiment of the present invention is set equal to or above 500 ppm, preferably in a range from 500 ppm to 1200 ppm, or more preferably in a range from 550 ppm to 900 ppm. For this reason, presence of electric conductivity enables processing into a complicated shape by an electro-discharge machining method. For example, the heater is manufactured by forming a columnar sample (the sintered body), slicing the sample in a diametric direction, and forming a spiral or concentric groove on the molded body.

This application claims the benefit of priority from the prior Japanese Patent Application filed by the applicant, namely, JP-A2006-112517 (filed on Apr. 14, 2006); the contents of which are herein incorporated by reference.

### INDUSTRIAL APPLICABILITY

According to the present invention, there is provided a small-sized in-line heater capable of rapid heating.

1. An in-line heater comprising:
a ceramic heater; and
two piping blocks each including a lid member and a piping block body in which a flow pipe is formed, the piping blocks being disposed to face each other with the ceramic heater interposed in between.

2. The in-line heater according to claim 1, wherein the ceramic heater is made of sintered silicon carbide.

3. The in-line heater according to claim 1, further comprising insulating bodies each disposed between the ceramic heater and one of the piping blocks.

4. The in-line heater according to claim 1, wherein the piping blocks are made of SUS.

5. The in-line heater according to claim 1, wherein the piping blocks are made of aluminum.

6. The in-line heater according to claim 1, wherein the piping blocks are made of quartz.

7. The in-line heater according to claim 1, further comprising reflectors respectively disposed on outer surfaces of the piping blocks.

8. The in-line heater according to claim 7, wherein the reflectors each comprise a gold-plated layer on a surface.
